(19) United States
(12) Patent Application Publication
(10) Pub. No.: US 2015/0355133 A1
(43) Pub. Date: Dec. 10, 2015

(54) NANO-WELL BASED ELECTRICAL IMMUNOASSAYS

(71) Applicant: THE BOARD OF REGENTS OF THE UNIVERSITY OF TEXAS SYSTEM, Austin, TX (US)

(72) Inventor: Shalini PRASAD, Austin, TX (US)

(21) Appl. No.: 14/759,750

(22) PCT Filed: Jan. 7, 2014
(86) PCT No.: PCT/US14/10492

§ 371 Date: Jul. 8, 2015

Related U.S. Application Data
(60) Provisional application No. 61/751,003, filed on Jan. 10, 2013.

(51) Int. Cl. G01N 27/327; G01N 27/403; G01N 27/49

(52) U.S. Cl. CPC G01N 27/3278; G01N 27/49; G01N 27/403; G01N 27/3276; G01N 27/3277

(57) ABSTRACT

In some embodiments, the compositions and methods relate to nano-well sensors and methods for using the same to detect target molecules in samples. In some embodiments, the nano-well chip comprises three parts: (a) a solid substrate, (b) a nanoporous nylon membrane situated on the top surface of the solid substrate, and (c) a polymer on top of and surrounding the nano-porous nylon membrane.

### CROSS-REFERENCE TO RELATED APPLICATIONS

This application claims the benefit of priority of U.S. Provisional Patent Application No. 61/751,003 filed on Jan. 10, 2013, which is hereby incorporated by reference in its entirety.

This invention was made with government support under grant number K9702A-A awarded by the Office of Naval Research. The government has certain rights in this invention.

### BACKGROUND OF THE INVENTION

A. Field of the Invention

The invention generally relates to methods and compositions useful for detecting target molecules. In particular, the invention relates to the use of microarray platforms to detect molecules.

B. Description of Related Art

Current ELISA plates achieve enhanced sensitivity and lower limits of detection by coupling the planar plates with micro and nanoscale particles or beads to increase the surface area for binding. Additionally, the use of these spherical transporter molecules also acts as amplifiers for the fluorescent signals. Standard ELISA plates with bead transporters are hindered by many limitations. For example, they require the incorporation of beads that leads to signal variability and change in signal baseline for the fluorescent signal, there are issues with quenching the fluorescent signal resulting in measurement perturbation while measuring proteins with low limits of detection from complex samples, and the number if transporter beads per well cannot be accurately estimated.

Therefore, new apparatus and methods for detecting target molecules having low limits of detection are needed.

### SUMMARY OF THE INVENTION

In some embodiments, the compositions and methods disclosed herein relate to sensors and methods for detecting target molecules.

In some aspects, the invention relates to a sensor comprising a solid substrate having a top surface, a nano-porous nylon membrane situated on the top surface of the solid substrate, thereby creating a plurality of nano-wells, or nano-channels, and a polymer on top of and surrounding the nano-porous nylon membrane.

The solid substrate may be any suitable substrate, and may be any suitable shape or size. In some embodiments, the solid substrate is a printed circuit board. In some embodiments, it contains gold plating. In some embodiments, it comprises at least two conductors arranged in a capacitive relationship on the printed circuit board. The nano-porous nylon membrane may be any suitable nylon membrane, and may be any suitable shape or size.

The nano-wells may be any desired size and shape. In some embodiments, the nano-wells may have any desired and appropriate diameter. In some embodiments, the diameter may be about 1, 2, 3, 4, 5, 10, 15, 20, 30, 40, 50, 60, 70, 80, 90, 100, 200, 300, 400, 500, 600, 700, 800, 900, 1000 nm, or any number derivable therein. In some embodiments, the plurality of nano-wells has a uniform diameter. In other embodiments, the plurality of nano-wells can have different diameters. In some embodiments, the plurality of nano-wells comprises a first set of nano-wells having a first effective diameter and a second set of nano-wells having a second effective diameter. The nano-wells may have any appropriate cross section. In some embodiments, the cross section can be cylindrical, elliptical, hexagonal, or any other desired shape. In some embodiments, the nano-wells have a cylindrical cross section. The nano-wells may be consistent in shape or there may be two or more different shaped nano-wells. In some embodiments, the sensor may have nano-wells having two different cross-sections. In some embodiments, the nano-wells have a consistent size and shape. There may be any number of nano-wells present on the sensor. In some embodiments, the plurality of nano-wells may include 1, 2, 3, 4, 5, 10, 15, 20, 30, 40, 50, 60, 70, 80, 90, 100, 200, 300, 400, 500, 600, 700, 800, 900, 1000 nano-wells.

The polymer may be any appropriate polymer. In some embodiments, the polymer may be a transparent polymer. In some embodiments, the polymer may be an opaque polymer. In some embodiments, the transparent or opaque polymer may be a biocompatible polymer.

In some embodiments, the sensor may contain one or more sensitizing agents immobilized in the nano-wells. In some embodiments, the surface of the nano-porous nylon membrane and the top surface of the solid substrate may be treated. In some embodiments, the treatment may be covalent, ionic, or electrochemical functionalization.

In some embodiments, the solid substrate may comprise at least two conductors arranged in a capacitive relationship on a printed circuit board. In some embodiments, the solid substrate comprises a circuit board with gold plating. In some embodiments, the sensor may further comprise a spectrum analyzer in communication with the first conductor, the spectrum analyzer configured to produce an estimate of a received signal portion associated with a signature capacitance change for a predetermined frequency. In some embodiments, the spectrum analyzer is configured to produce an estimate of a received signal portion associated with at least two frequencies associated with a detection signature.

In another aspect, the invention provides a method comprising administering a sample to a sensor comprising a solid substrate having a top surface, a nano-porous nylon membrane situated on the top surface of the solid substrate, thereby creating a plurality of nano-wells, and a polymer on top of and surrounding the nano-porous nylon membrane, evaluating an electrical signal associated with administration of the sample to the nano-porous nylon membrane, and assessing the sample based on the evaluation. In some embodiments, assessing the sample may include identifying the presence of or concentrations of a target molecule in the sample. In some embodiments, the plurality of nano-wells are evaluated simultaneously. In some embodiments, the plurality of nano-wells are evaluated in sequence.

The sample may be from any appropriate source. In some embodiments, the sample is from a human or non-human organism. In some embodiments, the human sample is whole blood, serum, urine, saliva, or sweat. In some embodiments, the non-human sample is whole blood, serum, urine, saliva, or sweat. In some embodiments, the sample is an environmental sample. In some embodiments, the environmental sample is a soil sample or a water sample.

In some embodiments, the method further comprises measuring capacitance/impedance at least one time. In some embodiments, the method comprises measuring capacitance/impedance at least two times. In some embodiments, a dose dependent increase in capacitance/impedance change indicates the presence of target biomolecules. In some embodiments, a dose independent transient to capacitance/impedance indicates non-specific binding to the sensor surface.

The term “about” or “approximately” are defined as being close to as understood by one of ordinary skill in the art, and in one non-limiting embodiment the terms are defined to be within 10%, preferably within 5%, more preferably within 1%, and most preferably within 0.5%.

The use of the word “a” or “an” when used in conjunction with the term “comprising” may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The compositions and methods for their use can “comprise,” “consist essentially of,” or “consist of” any of the ingredients or steps disclosed throughout the specification. Compositions and methods “consisting essentially of” any of the ingredients or steps disclosed limits the scope of the claim to the specified materials or steps which do not materially affect the basic and novel characteristic of the claimed invention.

It is contemplated that any embodiment discussed in this specification can be implemented with respect to any method or composition of the invention, and vice versa. Furthermore, compositions of the invention can be used to achieve methods of the invention.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates one embodiment of the nano-well sensor technology.

FIG. 2 illustrates the performance of the sensor in detecting Troponin-T from phosphate buffered saline and from human serum samples. Sensitivity has been achieved in the attogram regime.

FIGS. 3A-B (a) Randell's cell equivlant circuit representing the individual elements contributing to electrochemical impedance measurements (b) modified Randell's cell representing non-faradaic nanochannel sensor circuit. Charge transfer resistance is negligible due to absence of a redox probe.

FIGS. 4A-D (a) Optical image of the nano-well sensor with the PDMS encapsulant for fluid confinement and nano-wells for size-based confinement and “macromolecular crowding”; (b) scanning electron micrograph top view showing channel diameter of 200 nm; (c) cross-sectional scanning electron micrograph showing thickness of each nano-well; (d) cross-sectional representation of protein binding events in the nano-well.

FIG. 5 illustrates the method for preparing one embodiment of the nano-well sensor.

FIG. 6 illustrates a schematic representation of binding in the nano-wells.

FIG. 7 illustrates Azoxystrobin antibody saturation as determined during an antibody saturation study.

FIGS. 8A-D illustrate the results of a fungicide dose response study with Aoxystrobin without hapten. (A) Azoxystrobin attogram regime without hapten; (B) Azoxystrobin femtogram regime without hapten; (C) Azoxystrobin picogram regime without hapten; (D) Azoxystrobin nanogram regime without hapten.

FIGS. 9A-D illustrate the results of a fungicide dose response study with Aoxystrobin with hapten. (A) Azoxystrobin attogram regime with hapten; (B) Azoxystrobin femtogram regime with hapten; (C) Azoxystrobin picogram regime with hapten; (D) Azoxystrobin nanogram regime with hapten.

FIGS. 10A-D illustrate a comparison of the results with and without hapten. (A) Azoxystrobin attogram regime with hapten versus without hapten; (B) Azoxystrobin femtogram regime with hapten versus without hapten; (C) Azoxystrobin picogram regime with hapten versus without hapten; (D) Azoxystrobin nanogram regime with hapten versus without hapten.

FIGS. 11A-D illustrate the results of a fungicide dose response study with Trifloxystrobin without hapten. (A) Trifloxystrobin attogram regime without hapten; (B) Trifloxystrobin femtogram regime without hapten; (C) Trifloxystrobin picogram regime without hapten; (D) Trifloxystrobin nanogram regime without hapten.

FIGS. 12A-D illustrate the results of dose response studies achieved with Prostate Specific Antigen (PSA) as well as estimation of PSA from patient samples using the device. (A) Dose Response of PSA femtogram regime; (B) Dose Response of PSA attogram regime; (C) Dose Response of PSA pictogram-nanogram regime; (D) comparison of actual versus estimated concentration.

### DESCRIPTION OF ILLUSTRATIVE EMBODIMENTS

To overcome the issues with the previous detection systems, the nanowell sensor technology offers a cost effective, label-free alternative towards achieving low limits of detection. This technology can be multiplexed and rapid assessment is achieved by incorporating electrical and electrochemical measurement methodologies.

### A. Nano-Well Chip

The nano-well chip is a rigid substrate-based miniaturized multi well plate technology. The chip comprises three parts: (a) a solid substrate with a design which maximizes the surface area, (b) a nano-porous nylon membrane situated on the top surface of the solid substrate, and (c) a polymer on top of and surrounding the nano-porous nylon membrane.

The solid substrate can be made of any appropriate material. The basic functions of the solid substrate are to provide a scaffold for the polymer membrane to generate the nanowell spaces for biomolecule confinement, to act as a conduction base for the nanowell to obtain electrical signals, to provide a base of the nanowells suitable for surface functionalize towards achieving control in orientation for biomolecule confinement, and to create biomolecule confinement within the electrical double layer for obtaining electrical signal amplification. In some embodiments, the solid substrate is a printed circuit board. In some embodiments, it contains gold plating. In some embodiments, it comprises at least two conductors arranged in a capacitive relationship on the printed circuit board.

The polymer may be any polymer which results in the desired result. The purpose of the polymer is to minimize electrical cross reactivity from individual nanowells and to provide the ability to control hyrophoic/hydrophilic behavior. In some embodiments, the polymer is a biocompatible polymer, which prevents degradation of biomolecules. In some embodiments, the polymer is a transparent polymer. A transparent polymer may be useful in situations where membrane visibility is necessary, for example for some types of sensing which introduce a colorimetric tag at certain times. In other embodiments, the polymer is an opaque polymer. In particular embodiments, a microfluidic chamber fabricated using polydimethylsiloxane (PDMS) may be used to encapsulate the metallic electrode and nylon membrane, creating a sealed chamber.

In contrast to previous sensors, the nano-porous membrane is not made of a metal, such as aluminum. Rather, it is a nylon membrane. This difference results in surprisingly distinct functionalities. For example, the nano-well may be cylindrical in cross section in nanoporous nylon but will be funnel shaped in alumina. The funnel shape of alumina does not enable the discrimination between specific versus non-specific binding by a binary change to the measured signal, as is possible with the nylon membrane. Furthermore, the nano-porous nylon membrane enables the generation of nano-wells which can be individually electrically modeled, and the nano-porous nylon membrane in combination with the solid substrate results in a plurality of nano-wells. The nano-wells may have any number of desired sizes and shapes to accommodate a variety of possible target molecules for detection and analysis. Nanowell tailoring is also important to allow for tailoring the debye length of the biomolecule complexes to fit within the electrical double layer to maximize the electrical measurements obtained. The plurality of nano-wells may have a consistent size and shape or a variety of sizes and shapes, to detect more than one variety of target molecule. In particular, the nano-wells may have any desired and appropriate diameter. In some embodiments, the diameter may be about 1, 2, 3, 4, 5, 10, 15, 20, 30, 40, 50, 60, 70, 80, 90, 100, 200, 300, 400, 500, 600, 700, 800, 900, 1000 nm, or any number derivable therein. In some embodiments, the plurality of nano-wells has a uniform diameter. In other embodiments, the plurality of nano-wells can have different diameters. In some embodiments, the plurality of nano-wells comprises a first set of nano-wells having a first effective diameter and a second set of nano-wells having a second effective diameter. Similarly, the nano-wells may have any appropriate cross section. In some embodiments, the cross section can be cylindrical, elliptical, hexagonal, or any other desired shape.

In some embodiments, a sensitizing agent may be used in conjunction with the nano-well chip. The sensitizing agent is used to immobilize the biomolecules or receptors for the target species in a specific orientation into the nanowells. In some embodiments, one or more different sensitizing agents may be employed. Similarly, the surface of the nano-porous nylon membrane and the top surface of the solid substrate may be treated. Examples of treatments include, but are not limited to, covalent, ionic, or electrochemical functionalization. Such treatments are useful for maximizing the electrical signal obtained, thus enhancing the sensitivity as well as reducing the cross reactivity of the sensor.

The assembled chip can be connected to the measurement circuitry in any appropriate manner. In some embodiments, the chip is connected to the measurement circuitry by gold leads. The form factor of the chip can be controlled and scaled by modification to the printed chip board (PCB) design and the modular assembly process. In some embodiments, the form factor of the PCB may be designed to match the detection slot in a hand held potentiostat system (Rowe, et al., 2011).

An example methodology of sensor chip assembly can be seen in FIG. 4. Figure X(a) shows the optical micrograph of the PCB base platform with the overlaid nylon membrane and the PDMS encapsulant, FIG. 4(b) is shows a scanning electron micrograph of the high density nanochannel array as visualized from the top of the sensor surface, FIG. 4(c) shows the optical micrograph of the nanochannels as visualized from the side cross section demonstrating the uniformity of the nanoscale confined spaces and FIG. 4(d) is the schematic representation of protein binding events on the electrode surface.

### B. Method of Detection

While the platform appears to be a miniaturized version of the ELISA multiwell plate, it operates very differently. Unlike ELISA plates where individual wells are evaluated independently, in the sensor system the nanowells are evaluated simultaneously, this provides signal enhancement when measurement is taken electrically or electrochemically. The nano-well chip can be used for detecting single as well as multiple target molecules. Furthermore, since the nano-well chip operates without the use of reporter tags, it is a label free technology.

### 1. Principle of Operation

Detection of activity of the target molecules using the nano-well biosensor device is achieved through electrochemical impedance spectroscopy (EIS), which is based on the principle of double layer capacitive measurement, which is translated into an impedance change measured from a calibrated baseline (Bothara, et al., 2008; Reddy, et al, Sensors J, 2008; Reddy, et al., JALA, 2008). An electrical double layer is formed at the solid/liquid interface at the base of each nanochannel. This layer may be any appropriate thickness. In particular embodiments, it may be approximately 20-50 nm in thickness.

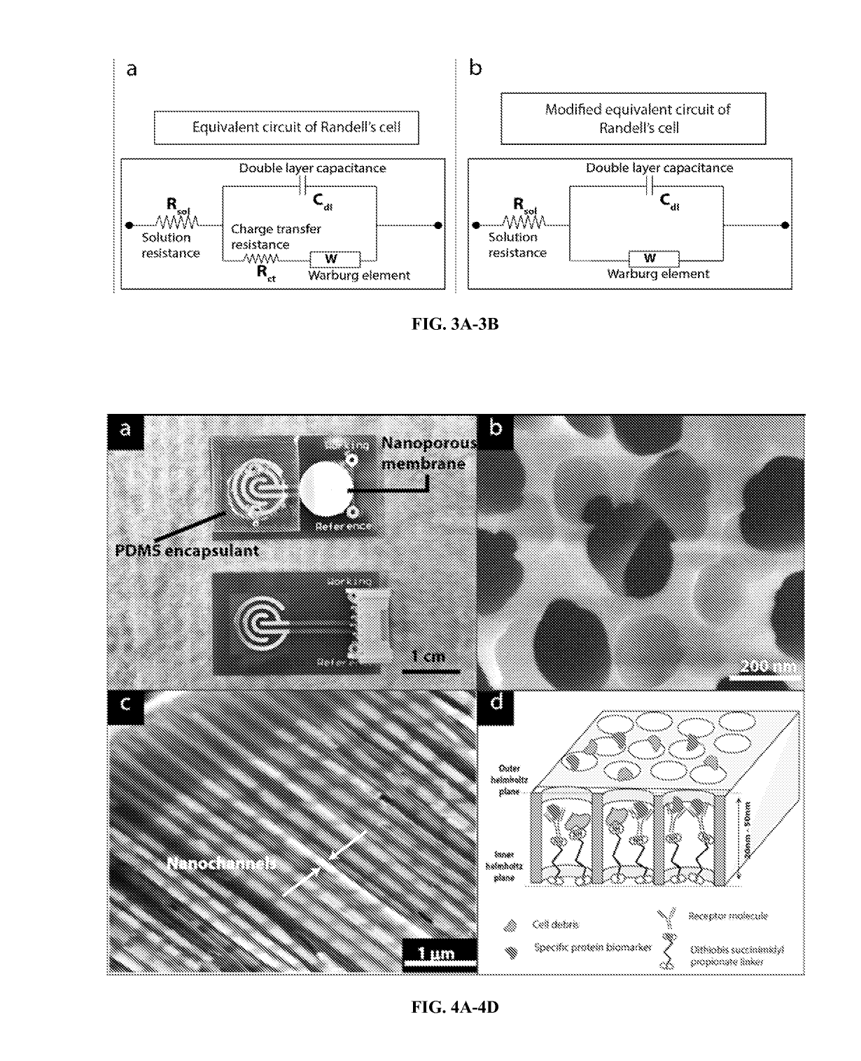

The changes in the electrochemical properties of the solution in the nanochannel biosensor device brought about by mutual volume exclusion within the nanochannels of the nylon membrane are quantified using electrochemical impedance spectroscopy (EIS). The name “impedance spectroscopy” is derived from the fact that the impedance is generally determined at different frequencies rather than at just one. Thus, an impedance spectrum is obtained that allows the characterization of surfaces, layers, or membranes, as well as exchange and diffusion processes. In a particular aspect, the impedance variations that occur at the electrical double layer (EDL) that forms at the solid-liquid interface of the electrode above the surface of the chip. To achieve a characterization of the EDL, the impedance spectrum may be analyzed using any appropriate circuit. In particular embodiments, a Randell's equivalent circuit may be used. An example circuit is shown in FIG. 3(a), which consists of a combination of resistors and capacitors connected in a series/parallel fashion, represents the different physicochemical properties of the system under investigation (Lisdat, et al., 2008). In this case, the change of one impedance element—a series combination of a resistor and a capacitor as a function of the analyte solution composition was evaluated. A second example circuit is shown in FIG. 3(b), which considers the charge transfer resistance to be negligible. The charge transfer resistance does not play a role in the measurement modality implemented in this paper as a redox probe has not been used to detect protein binding.

A low voltage (1 mV-2V) alternating current is applied across the sensor device and the frequency scanned. In some embodiments, the frequency may be scanned from 1 mHz to 10 kHz. The impedance is then measured across the working electrode and counter-electrode of the metallic electrode-sensing site, by means of an impedance analyzer (Gamry Ref 600 Potentiostat, Gamry instruments, PA, USA). From this frequency range the frequency point at which (a) maximum change to the impedance with biomolecule binding and (b) the change in impedance is positive for specific binding events and zero or negative for non-specific binding events is identified. This is done by tuning the circuit in FIG. 3B to maximize the double layer capacitance measurements.

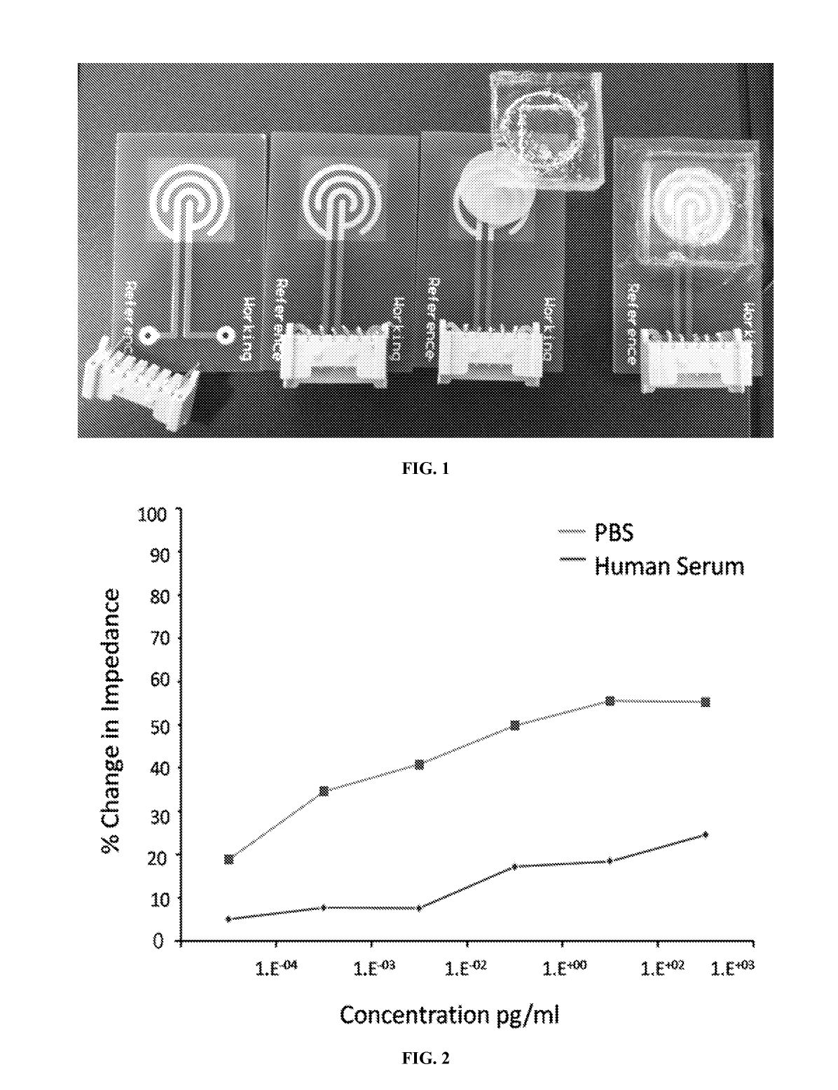

The measurement modality of electrochemical impedance spectroscopy detected protein-binding events in the form of change in impedance from a specific baseline impedance, which correlated to the device background noise. By tuning the frequency of measurement, the measured change in impedance values reflected that the protein binding events occurred at the electrical double layer. The two components of impedance that contributed to the measurement were resistance and capacitance. The imaginary part of impedance, which was the capacitance, was not the sole consideration in this study as the cell lysate solution applied to the nanosensor contained cell debris and resistive components. The measurement of capacitance over a resistive solution component did not correlate directly to protein binding events happening at the electrical double layer. The rationale behind this was that the resistive components induced noise in the capacitive measurements. To reduce noise background, the modulus of impedance, which measured both resistance and capacitance, was used in this study. The effect of both the resistive and capacitive components were taken into account, but at low frequencies (<1 kHz) at which the nanosensor operated the primary contribution to the impedance was from the capacitive component which was reflective of the protein binding based changes to the electrical double layer. The binding of the proteomic markers to the antibodies at EDL interface produces specific and measurable change to impedance within each nanochannel. The cumulative change in the impedance across the entire array of nanochannels was measured from the gold microelectronic sensing site as shown in FIG. 1(d). As the binding of the biomolecules occurred directly on the metallic surface and was not mediated through a redox probe (Lisdat, et al., 2008), the impedance changes are non-faradaic in nature.

### 2. Signal and Background Noise

Two types of signals: specific/significant signal and non-specific/noise signal were defined for the system. The measurement protocol from the nanosensor chip followed a standard single capture immunoassay protocol. Impedance changes from the baseline as well as from the buffer wash were computed for each of the steps of the immunoassay [linker conjugation, antibody immobilization, block application and sample (antigen) interaction]. The noise signal was defined as the impedance change measured from an antibody/antigen dose to the phosphate buffered saline (PBS) wash following the assay step. The PBS wash step correlated to a zero protein dose, and the maximum change in impedance observed for the buffer wash step was 6% from the sensor baseline measurement in the absence of any buffer. This change in impedance from the baseline was defined as the noise signal. Hence a change in impedance of 6% or less from the previous measurement in the assay process was considered as noise. Conversely, a change in impedance of >6%, the signal was classified to be of specific nature and considered significant to the sensor.

### 3. Electrode Surface Functionalization

In some embodiments, the surface of the electrodes may be functionalized. Functionalization of the nanochannels with the gold base electrode is achieved by coating the gold surface with the crosslinking agent dithiobis succinimidyl propionate, (DSP; Thermo Fisher Scientific Inc., IL, USA). DSP contains an amine-reactive N-hydroxysuccinimide ester at each end of two eight-carbon spacer arms that are linked together with a disulfide bond. The disulphide linkage of DSP chemisorbs rapidly to the gold surface forming monolayers of the DSP molecules on the gold surfaces while the N-hydroxysuccinimide groups are available for binding to the primary amine groups of proteins (Mattson, et al., 1993). After incubation of the electrode surface with DSP (4 mg/ml) for 30 min at room temperature, excess unreacted crosslinker is washed off twice with 0.15 M phosphate buffered saline (PBS).

### 4. Enhanced Sensitivity

The simultaneous evaluation allows for lowering the limit of detection in complex media samples. The ability to achieve enhanced sensitivity due to the reduction in the background noise floor when compared to the other nanotechnology based sensors allows the sensor to show attogram/mL sensitivity. Enhanced selectivity also known as reduced cross reactivity is achieved due to the surface treatment of the nylon membranes. For example, this enhanced selectivity allows for ag/mL sensitivity in detecting target protein biomoleules from complex samples such as human serum. FIG. 2 shows the performance of the sensor in detecting Troponin-T from phosphate buffered saline and from human serum samples. Sensitivity has been achieved in the attogram regime.

### 5. Samples

The sample to be analyzed may be any relevant sample from which target molecules may be detected. Examples include, but are not limited to, biological samples such as whole blood, serum, urine, saliva, or sweat, and environmental samples such as soil or water.

The simultaneous evaluation also allows for the use of a small sample size. While previous sensor systems require the use of a minimum of 200 μl, the nano-well chip requires as little as 20 μl of sample.

### C. Fields of Use

The assays and sensors disclosed herein may be used in a wide variety of settings. Examples include, but are not limited to, the analysis of clinical samples and environmental samples.

In some embodiments, the nano-well chip may be used to detect biomolecules in a sample from a patient. Such an assay may be useful for diagnostics or other clinical purposes relating to a range of diseases including cardiovascular diseases, cancer, and infectious diseases. Examples of samples include, but are not limited to, patient whole blood, serum, urine, saliva, and sweat. In such assays, detection in the attogram/mL regime for protein biomarkers from standard laboratory buffers and human serum has been demonstrated.

In some embodiments, the nano-well chip may be used to detect small molecules in environmental samples such as soil or water samples. Such assays may be desired, for example, to identify trace pharmaceuticals or pesticides in drinking or river water. For trace pharmaceuticals, detection in the fg/mL regime is possible. For fungicides, detection in the ag/mL sensitivity is possible.

### D. EXAMPLES

The following examples are included to demonstrate certain non-limiting aspects of the invention. It should be appreciated by those of skill in the art that the techniques disclosed in the examples that follow represent techniques discovered by the applicants to function well in the practice of the invention. However, those of skill in the art should, in light of the present disclosure, appreciate that many changes can be made in the specific embodiments that are disclosed and still obtain a like or similar result without departing from the spirit and scope of the invention.

### Example 1

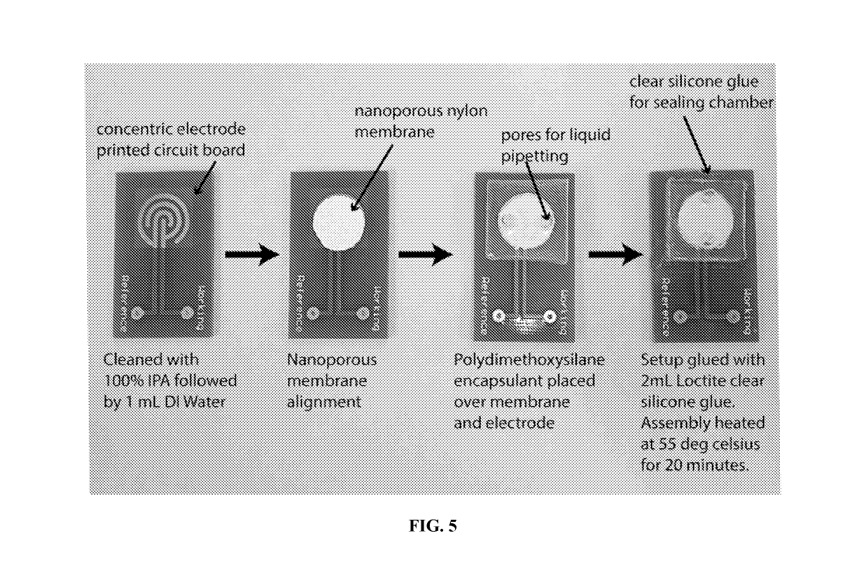

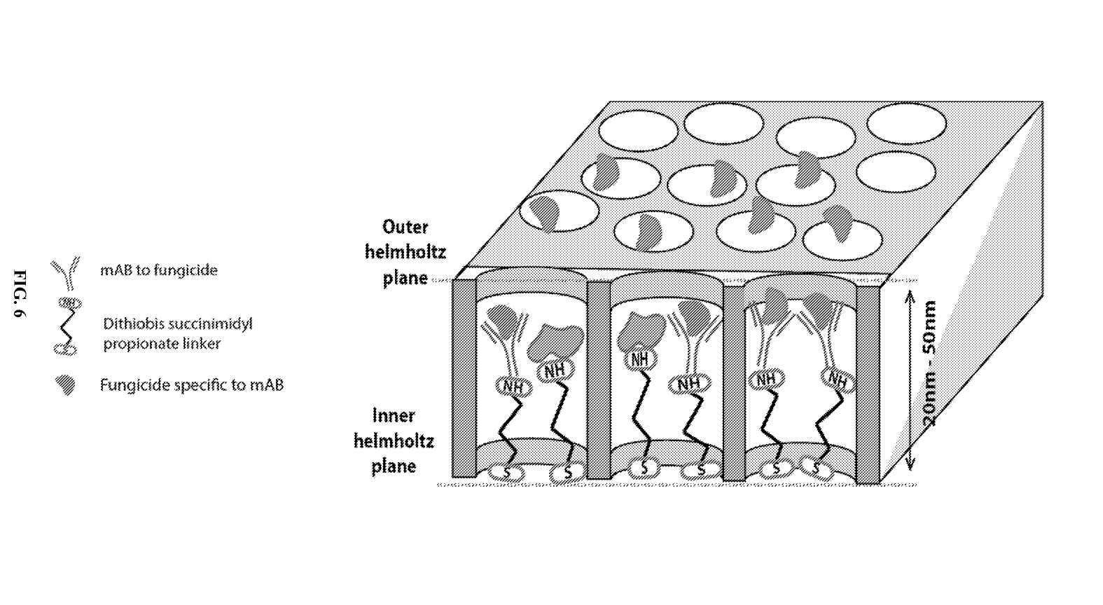

An example nano-well sensor may be made in the following manner (see FIG. 5). The printed circuit board (4 cm×2.5 cm) with the desired electrode pattern (interdigitated, concentric etc.) is chosen. The substrate of the PCB is cleaned with 100% Isopropyl alcohol (IPA) followed by 1 mL of deionized water and air dried. Nanoporous nylon membrane (of the necessary pore size (20 nm, 100 nm, 200 nm etc.) is aligned on top of the electrode pattern. PDMS manifolds are prepared using the Sylgard ® silicone elastomer kit (Dow Corning Corporation). The mold then heated at 100 degree Celsius for 30-45 minutes to cure them into the manifold. The mold has a groove to generate a recess to slide the nanoporous nylon membrane and obtain a hermetic seal. The manifold (1.5 cm×1.5 cm) helps in containing the reagent/analysis sample over the membrane and the electrode system. The above three components are assembled and 2 mL of Loctite® Clear silicone glue is applied between the manifold and PCB chip to hold them in place. Once glued, it is heat cured at 55° Celsius for 20 minutes to solidify the glue and completely seal the chamber.

### Example 2

Experiments were performed with a nano-well sensor comprising a printed circuit board substrate with gold electrodes, a nanoporous nylon membrane for nanoconfinement of molecules, and Poly Dimethoxy Silane encapsulant to hold the sample on top of the electrodes, where the sensor system was integrated with a potentiostat for performing the measurements. The best frequency for change in impedance measurement was found to be 100.4 Hz. Dithiobis succinimidyl propionate was used as the linker to conjugate mAB's to gold electrode surface, and mAB's specific to the fungicide under study were inoculated onto the sensing sites (i.e., the linker occupied regions on the electrode). Varying concentrations of fungicide were applied and impedance changes were observed. See FIG. 6. An antibody saturation study (using Azoxystrobin, Trifloxystrobin, and Pyraclostrobin) and a fungicide dose response study (using Azoxystrobin and Trifloxystrobin without hapten and Azoxystrobin with hapten as a sensitizing agent) were performed.

### Example 3

### Antibody Saturation Study

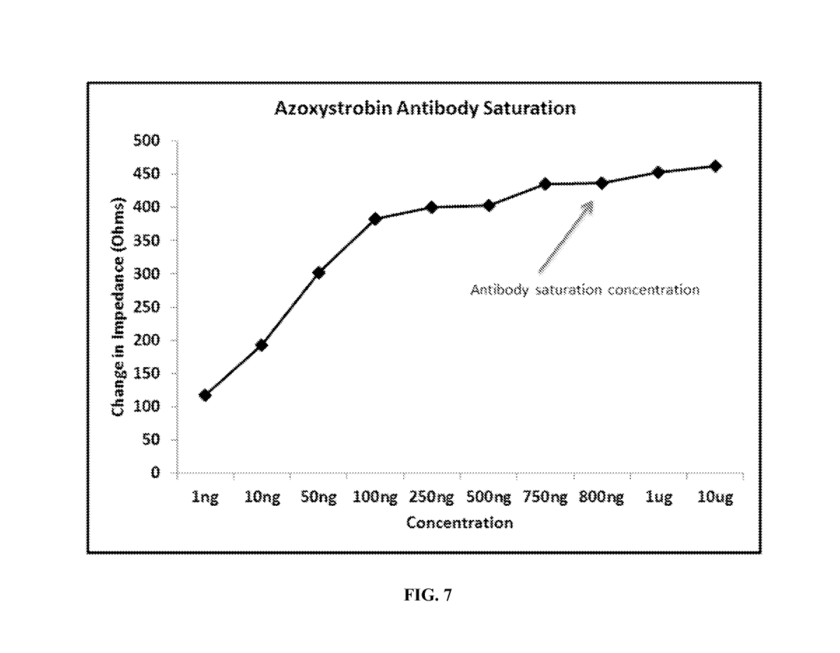

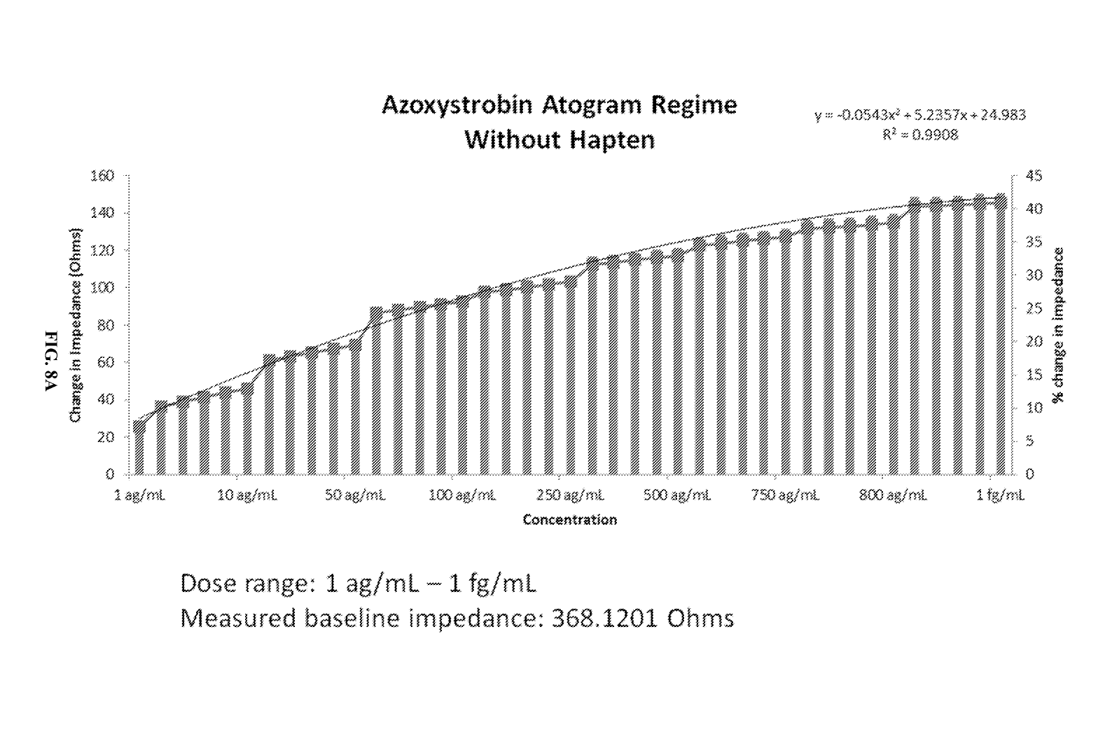

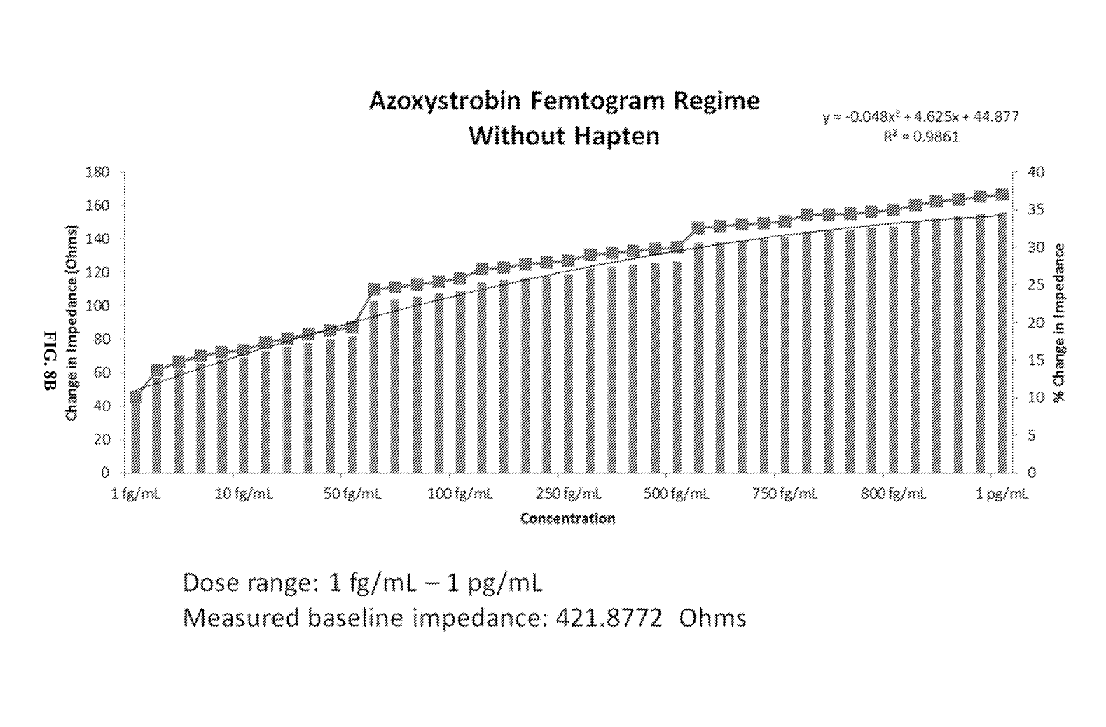

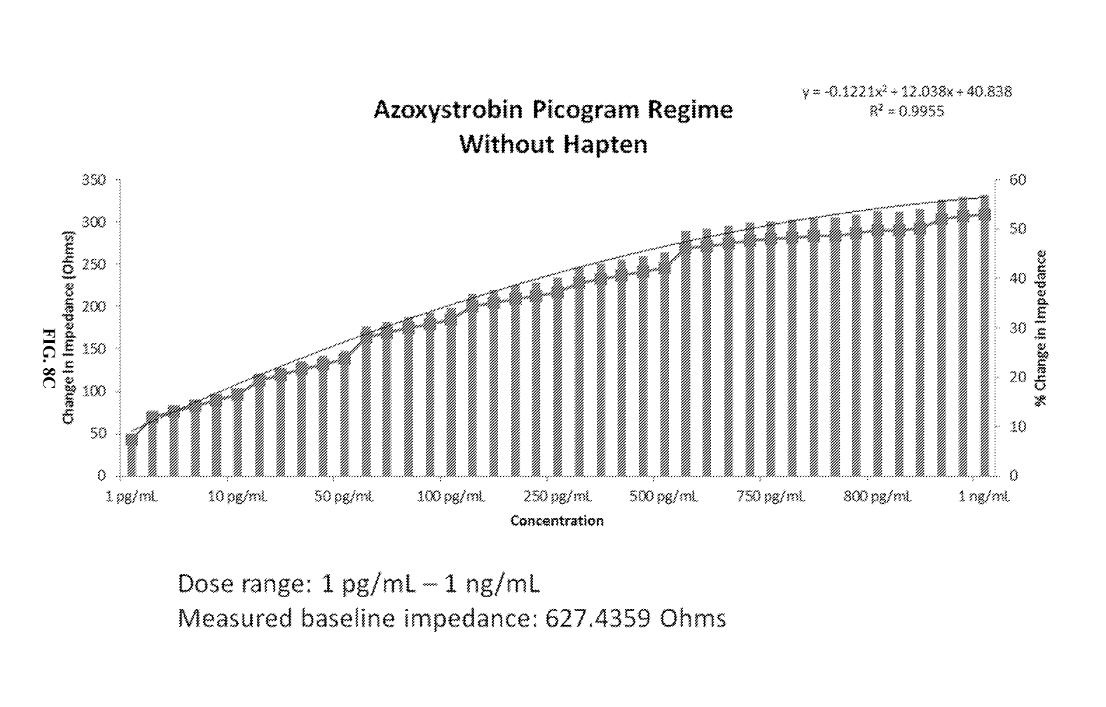

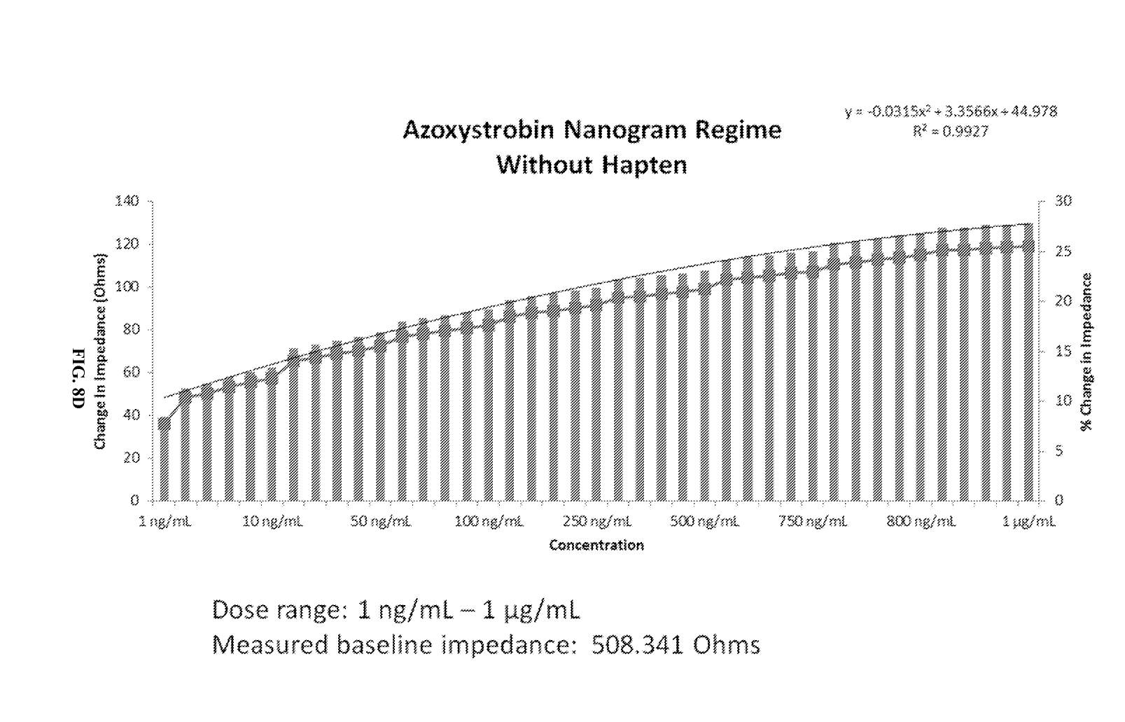

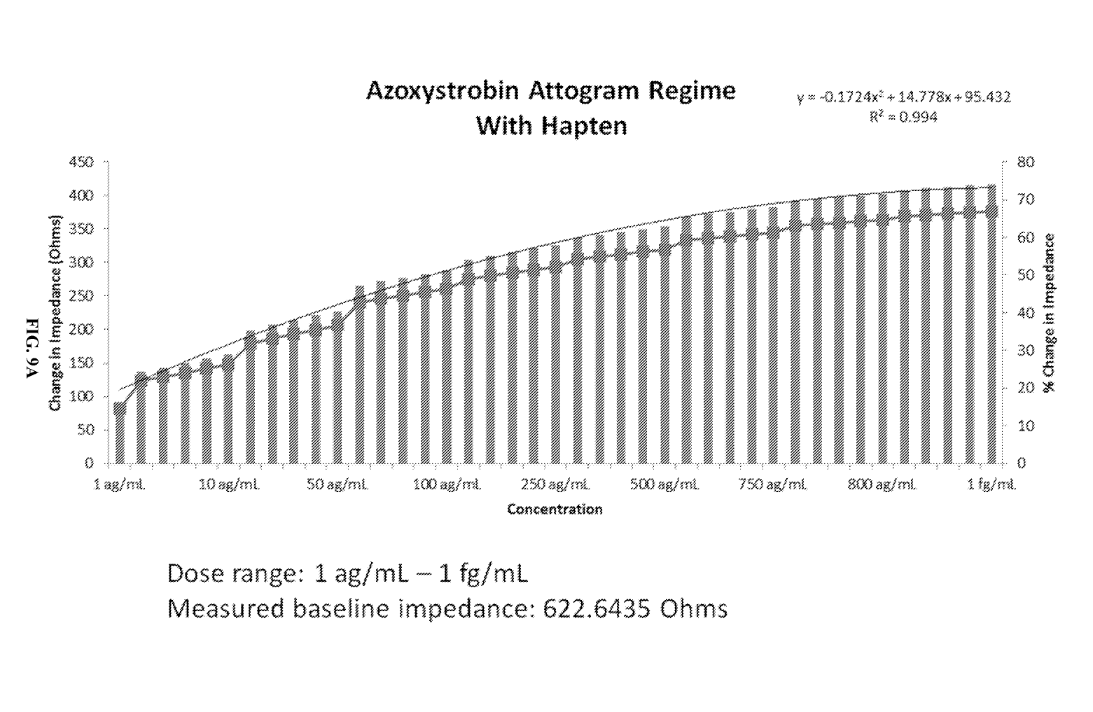

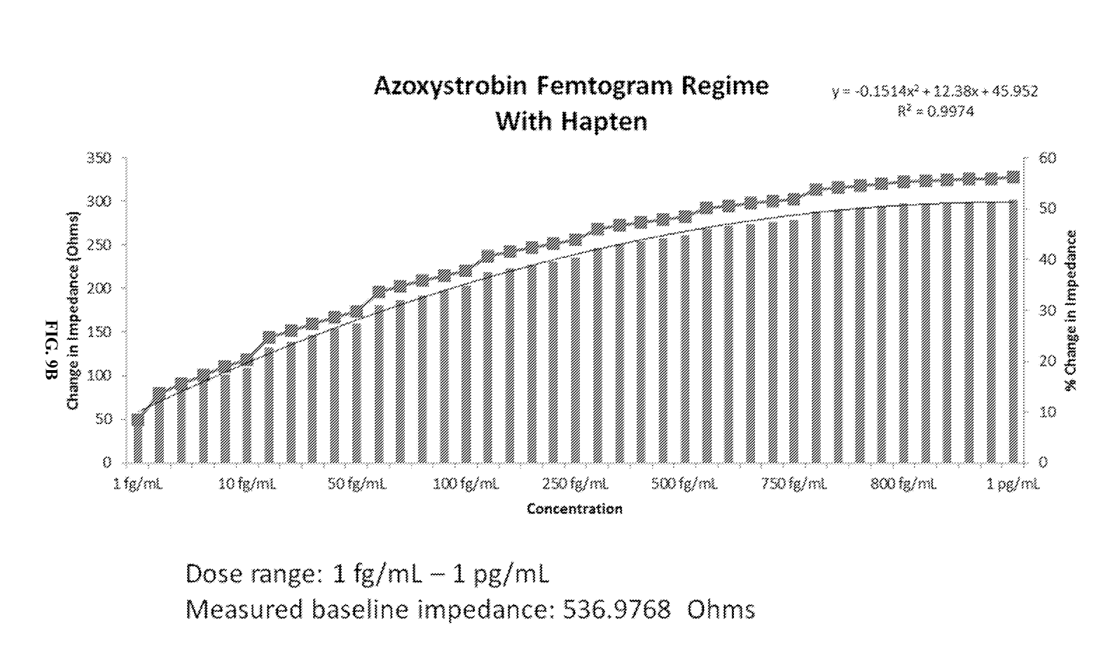

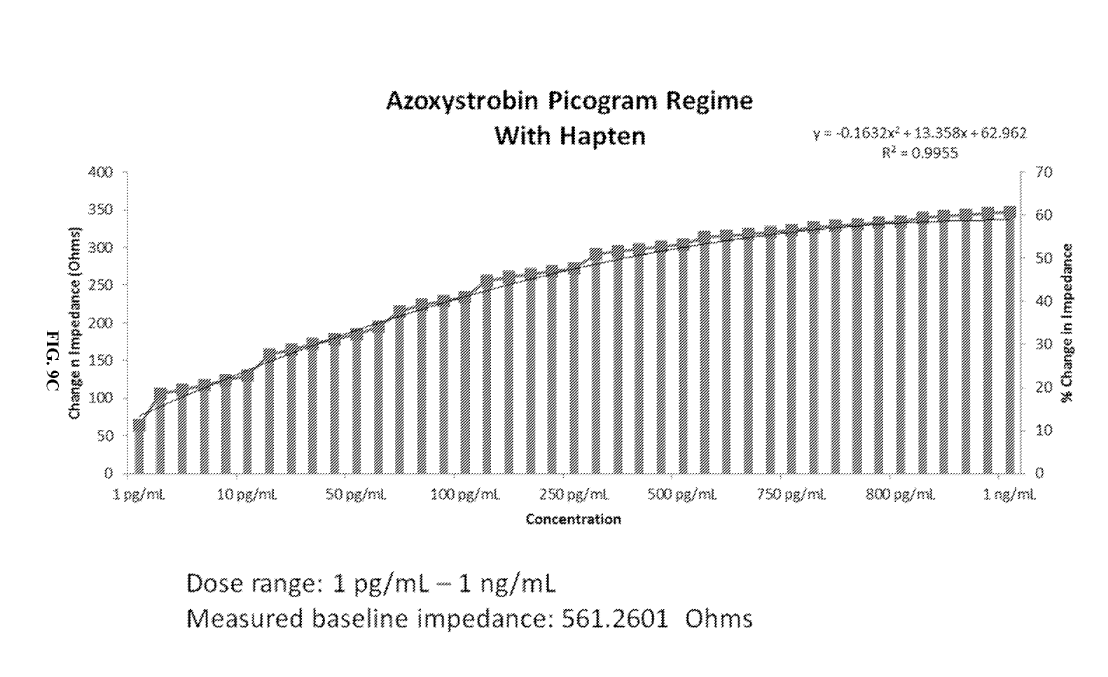

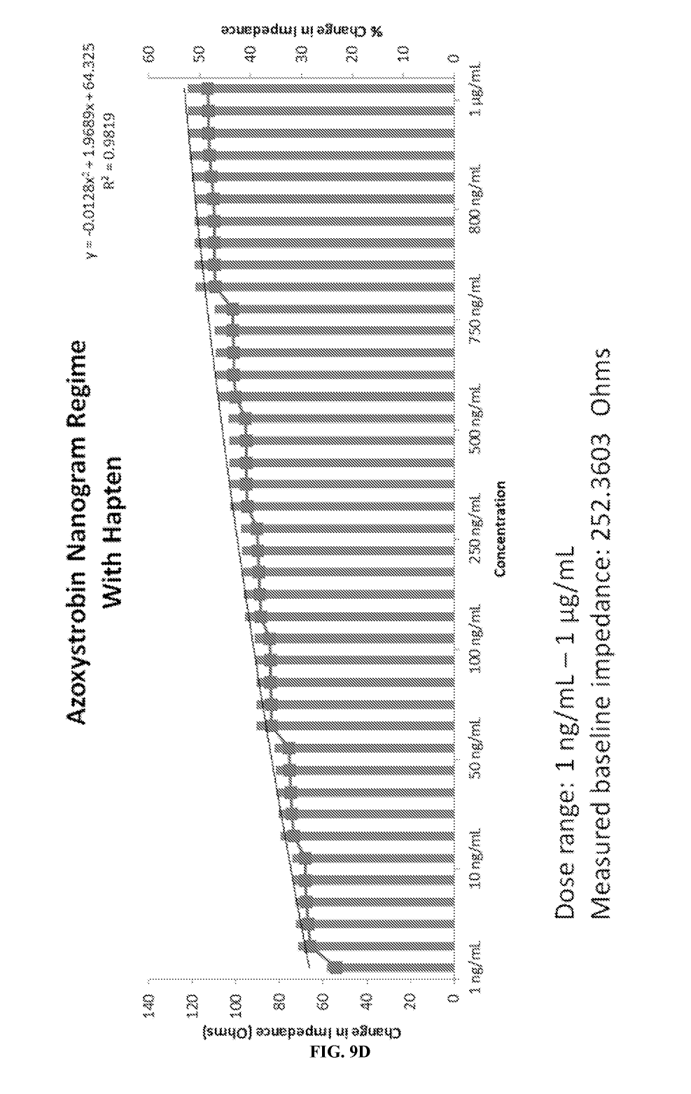

The antibody saturation study was carried out to determine the concentration of antibody necessary to saturate all sensing sites on the substrate surface with the antibodies. The study was carried out using a sensor comprising a concentric gold electrode patterned substrate, 200 nm nylon membrane, and 100 μl PDMS manifold as the encapsulant. Deposition was 10 mM DSP in DMSO for a 15 minute incubation. The concentrations studied for identifying antibody Saturation were 1 ng/mL, 10 ng/mL, 50 ng/mL, 100 ng/mL, 250 ng/mL, 500 ng/mL, 750 ng/mL, 800 ng/mL, lug/mL, 10 ug/mL, and 50 ug/mL. In between each concentration there is a 3×0 PBS wash and 15 minute incubation. As shown in FIG. 7, the saturation concentration is chosen as the point at which measured value of change in

Impedance saturates. The range of concentrations tested was 1 ng/mL-10 μg/mL. As the three antibodies are similar in function and class, the saturation concentration for all the antibodies used for the dose response was 1 μg/mL.

### Example 4

### Dose Response Study

Azoxystrobin without hapten. The dose response study was carried out using a sensor comprising a concentric gold electrode patterned substrate, 200 nm nylon membrane, and 100 μl PDMS manifold as the encapsulant. DSP in DMSO Deposition (10 mM) (15 minute incubation), Antibody Deposition (30 minute incubation) of 800 ng/mL of Azoxystrobin. Superblock Deposition (15 minute incubation). Antigen Dose Response was studied with nine points in each regime—ng/mL, pg/mL, fg/mL, ag/mL. In between each concentration there is a 3× PBS wash and 15 minute incubation. The results are shown in FIGS. 8A-D. The range of detection was 1 ag/mL-1 ug/mL and the limit of detection was 1 ag/mL.

Azoxystrobin with hapten. The dose response study was carried out using a sensor comprising a concentric gold electrode patterned substrate, 200 nm nylon membrane, and 100 μl PDMS manifold as the encapsulant. DSP in DMSO Deposition (10 mM) (15 minute incubation), Antibody Deposition (30 minute incubation) of 800 ng/mL of Azoxystrobin. Superblock Deposition (15 minute incubation). 10 mM Hapten to Azoxystrobin (30 minute incubation). Antigen Dose Response was studied with nine points in each regime—ng/mL, pg/mL, fg/mL, ag/mL. In between each concentration there is a 3× PBS wash and 15 minute incubation. The results are shown in FIGS. 9A-D. The range of detection was 1 ag/mL-1 μg/mL and the limit of detection was 1 ag/mL.

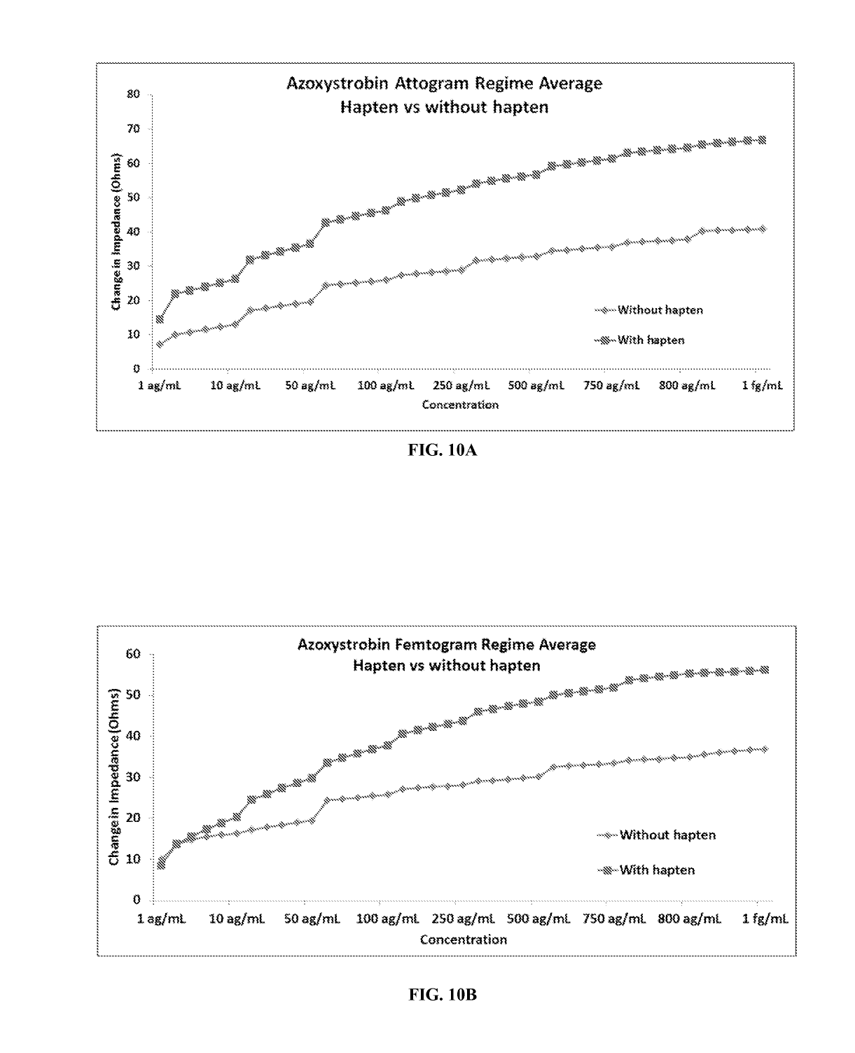

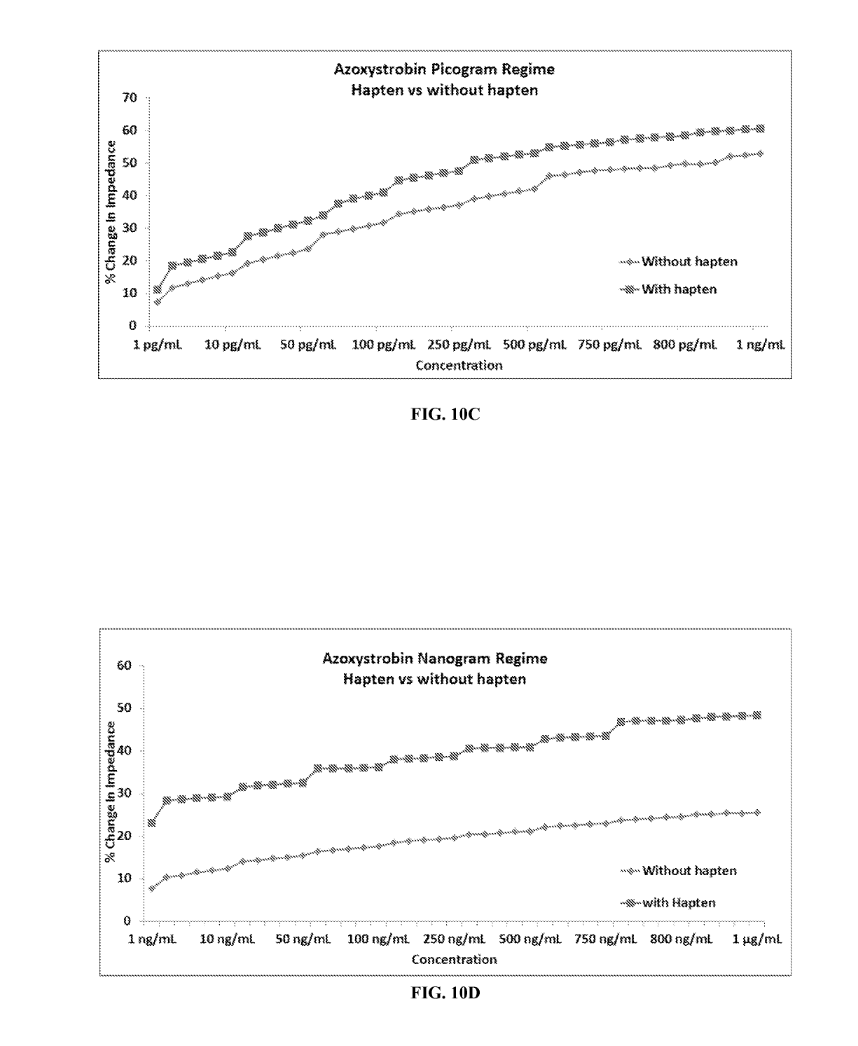

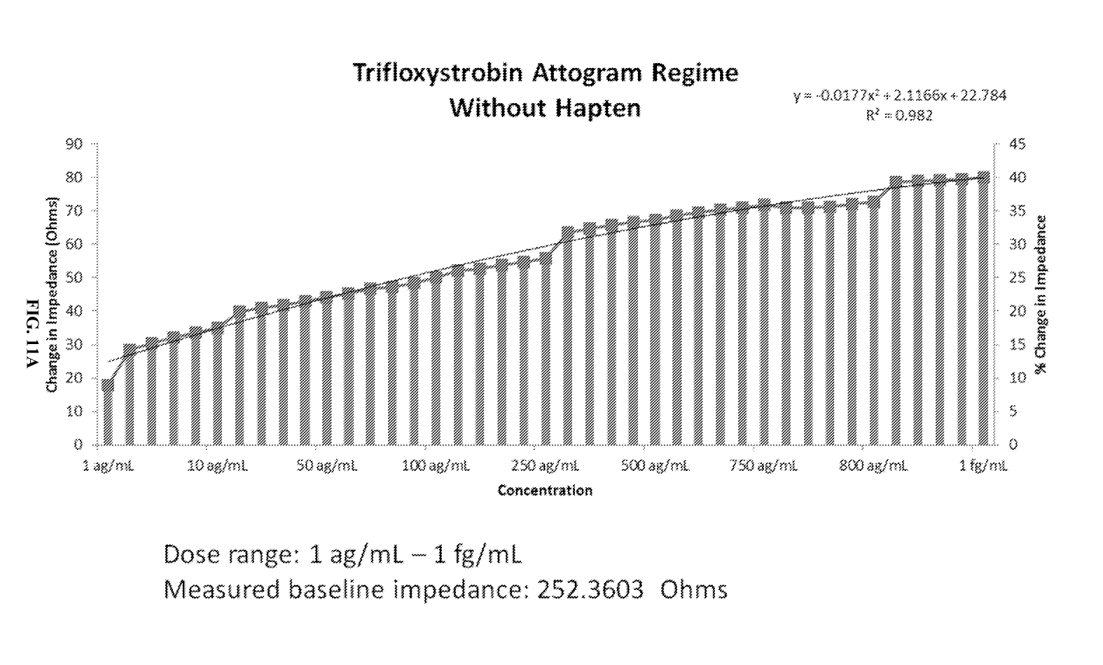

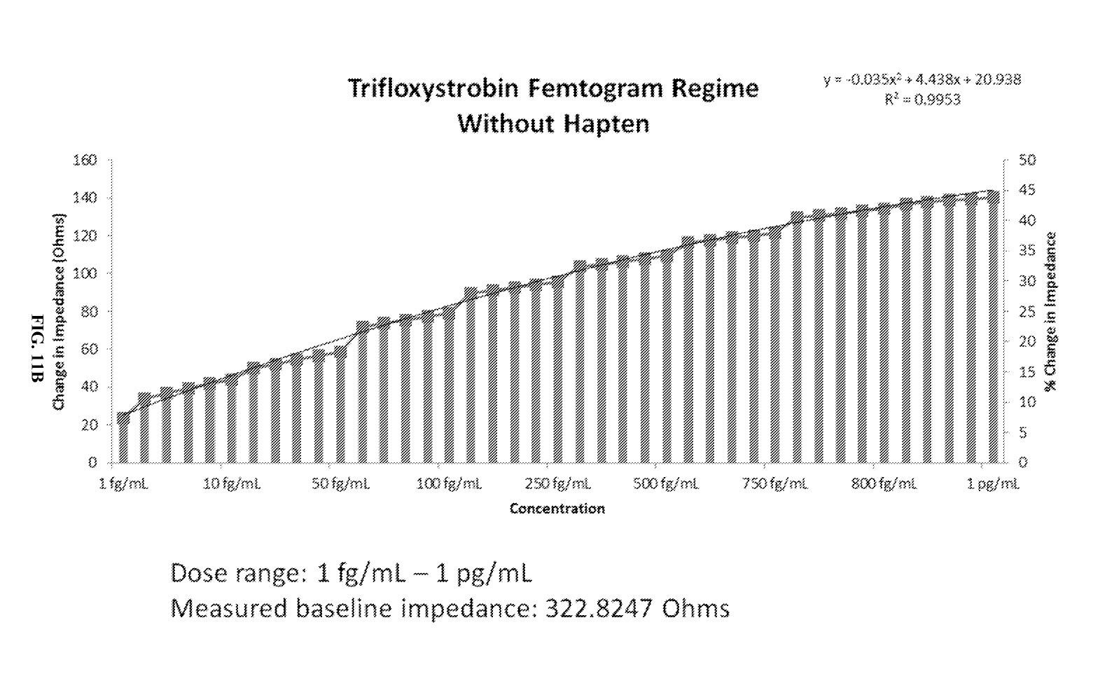

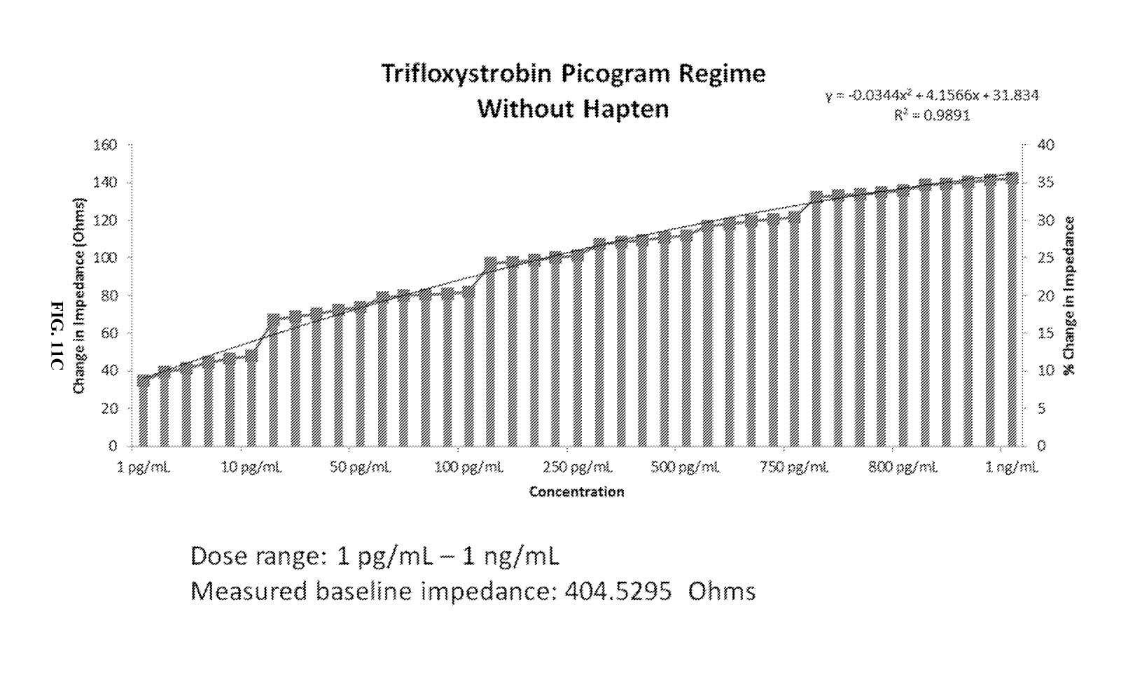

Comparison with and without hapten. The % change in impedance with hapten shows response in comparison to the study without hapten. See FIGS. 10A-D.

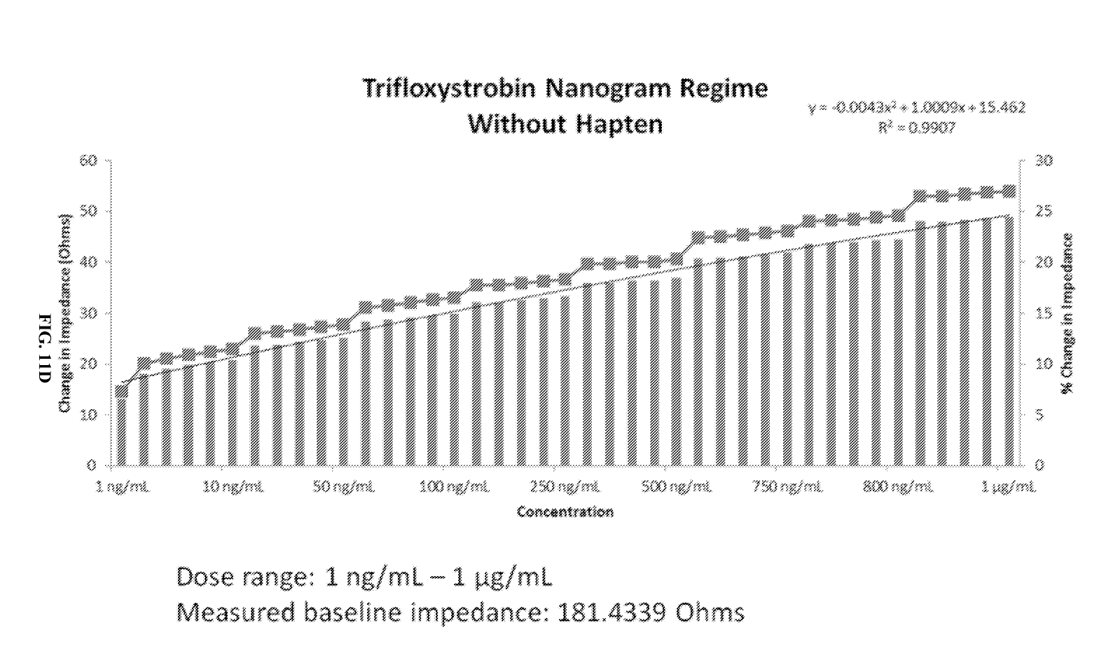

Trifloxystrobin without hapten. The dose response study was carried out using a sensor comprising a concentric gold electrode patterned substrate, 200 nm nylon membrane, and 100 μl PDMS manifold as the encapsulant. DSP in DMSO Deposition (10 mM) (15 minute incubation), Antibody Deposition (30 minute incubation) of 1 μg/mL of Trifloxystrobin. Superblock Deposition (15 minute incubation). Antigen Dose Response was studied with nine points in each regime—ng/mL, pg/mL, fg/mL, ag/mL. In between each concentration there is a 3×0 PBS wash and 15 minute incubation. The results are shown in FIGS. 11A-D. The range of detection was 1 ag/mL-1 m/mL and the limit of detection was 1 ag/mL.

### Example 5

To establish the validity of the sensor technology, two types of samples for Prostate Specific Antigen (PSA) were investigated. The first type of samples was of the purified form purchased from EMD Biosciences, San Diego Calif. The second type of samples was patient samples. Serial dilution of the purified PSA antigen was performed. Doses ranging from the attogram/mL regime to the nanogram/mL regime were evaluated. For the patient samples, untreated samples were introduced onto the antibody saturated sensor. All the antibodies used for both types of samples were in the monoclonal form to reduce non-specific binding and cross-reactivity.

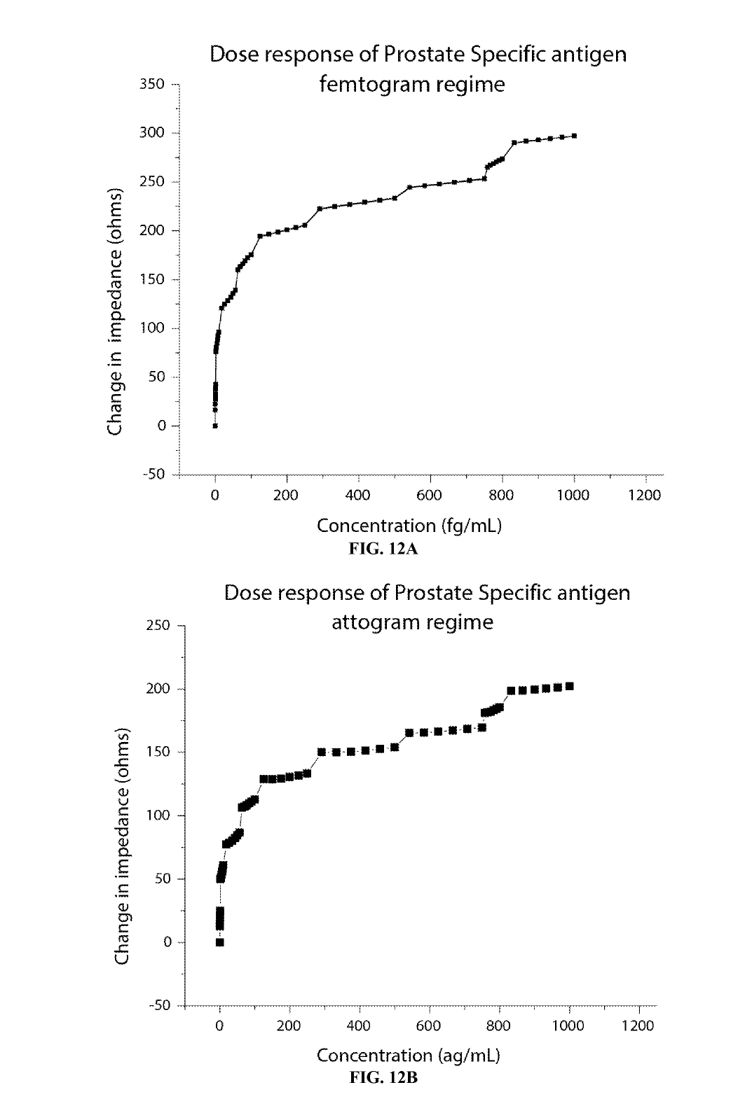

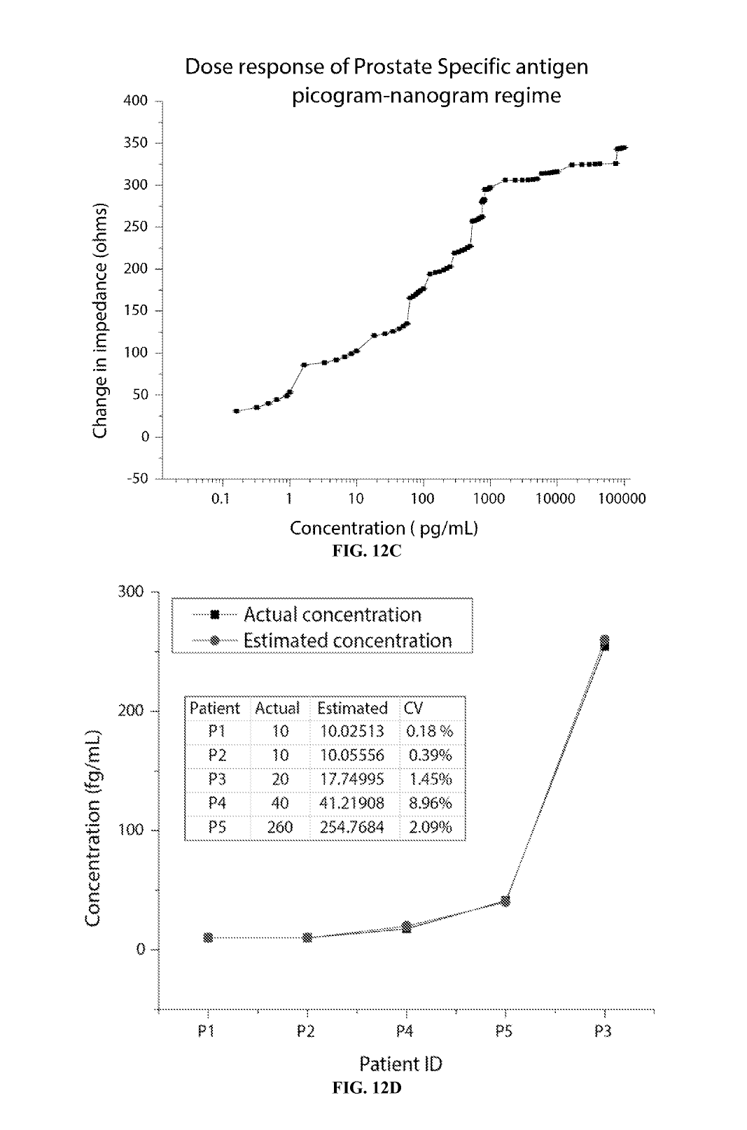

Each sensing site consists of a working and counter electrode and supported by high density array of nano-wells. The variation of the impedance was measured across these two electrodes. PSA aliquots at varying concentrations were inoculated onto separate antibody saturated sensing sites. After an incubation period of 15 minutes to enable antigen adsorption and the formation of the immuno-complex, the change in the impedance was measured with respect to the capacitance associated with antibody saturation. Due to the formation of the immuno-complex, the charges at the solid/liquid interface were modulated and this resulted in a change in the measured impedance. The lower limit of detection is the concentration value at which there is either zero or <6% change in the measured impedance from the baseline. See FIGS. 12A-D.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

### Bothara, et al., Nanomedicine. 3(4): 423-436, 2008.

### Lisdat & Schafer, Analytical and Bioanalytical Chemistry. 391(5): 1555-1567, 2008.

Mattson, et al., Molecular biology reports. 17(3): 167-183, 1993.

### Reddy, et al., Journal of the Association for Laboratory Automation. 13(1): 33-39, 2008.

### Reddy, et al., Sensors Journal, IEEE. 8(6): 720-723, 2008.

Rowe, et al., PLoS ONE. 6(9): e23783, 2011.

1. A sensor comprising:
a solid substrate having a top surface;
a nano-porous nylon membrane situated on the top surface of the solid substrate, thereby creating a plurality of nano-wells; and
a polymer on top of and surrounding the nano-porous nylon membrane.

2. The sensor of claim 1, wherein the plurality of nano-wells have a diameter from about 50 nm to about 1000 nm.

3. The sensor of claim 1, wherein the plurality of nano-wells comprises a first set of nano-wells having a first effective diameter and a second set of nano-wells having a second effective diameter.

4. The sensor of claim 3, wherein the first effective diameter is larger than the second effective diameter.

5. The sensor of claim 1, wherein the nano-wells have a cylindrical cross section.

6. The sensor of claim 1, wherein the cylindrical nano-wells have a consistent size and shape.

7. The sensor of claim 1, wherein a first sensitizing agent is immobilized in the nano-wells.

8. The sensor of claim 1, wherein the surface of the nano-porous nylon membrane and the top surface of the solid substrate is treated.

9. The sensor of claim 8, wherein the treatment is covalent, ionic or electrochemical functionalization.

10. The sensor of claim 1, wherein the solid substrate comprises at least two conductors arranged in a capacitive relationship on a printed circuit board.

11. The sensor of claim 1, wherein the solid substrate comprises a circuit board with gold plating.

12. The sensor of claim 1, wherein the polymer is a transparent polymer.

13. The sensor of claim 12, wherein the transparent polymer is a biocompatible transparent polymer.

14. The sensor of claim 1, further comprising a spectrum analyzer in communication with the first conductor, the spectrum analyzer configured to produce an estimate of a received signal portion associated with a signature capacitance change for a predetermined frequency.

15. The sensor of claim 14, wherein the spectrum analyzer is configured to produce an estimate of a received signal portion associated with at least two frequencies associated with a detection signature.

16. A method comprising:
administering a sample to a sensor comprising:
a solid substrate having a top surface;
a nano-porous nylon membrane situated on the top surface of the solid substrate, thereby creating a plurality of nano-wells; and
a polymer on top of and surrounding the nano-porous nylon membrane;
evaluating an electrical signal associated with administration of the sample to the nano-porous nylon membrane; and
assessing the sample based on the evaluation.

17. The method of claim 16, wherein assessing the sample comprises identifying the presence of or concentration of a target molecule in the sample.

18. The method of claim 17, wherein the sample is from a human.

19. The method of claim 18, wherein the human sample is a serum sample, a blood sample, or a urine sample.

20. The method of claim 17, wherein the sample is an environmental sample.

21. The method of claim 20, wherein the environmental sample is a soil sample or a water sample.

22. The method of claim 1, wherein the plurality of nano-wells are evaluated simultaneously.

23. The method of claim 16, wherein the plurality of nano-wells are evaluated in sequence.

24. The method of claim 16, wherein the plurality of nano-wells have a diameter from about 50 nm to about 1000 nm.

25. The method of claim 16, wherein the plurality of nano-wells comprises a first set of nano-wells having a first effective diameter and a second set of nano-wells having a second effective diameter.

26. The method of claim 25, wherein the first effective diameter is larger than the second effective diameter.

27. The method of claim 16, wherein the nano-wells have a cylindrical cross section.

28. The method of claim 16, wherein the cylindrical nano-wells have a consistent size and shape.

29. The method of claim 16, wherein a first sensitizing agent are immobilized in the nano-wells.

30. The method of claim 16, wherein the surface of the nano-porous nylon membrane is treated.

31. The method of claim 30, wherein the treatment is covalent, ionic or electrochemical functionalization.

32. The method of claim 16, wherein the solid substrate comprises at least two conductors arranged in a capacitive relationship on a printed circuit board.

33. The method of claim 16, wherein the solid substrate comprises a circuit board with gold plating.

34. The method of claim 16, wherein the polymer is a transparent polymer.

35. The method of claim 34, wherein the transparent polymer is a biocompatible transparent polymer.

36. The method of claim 16, wherein the sensor further comprises a spectrum analyzer in communication with the first conductor, the spectrum analyzer configured to produce an estimate of a received signal portion associated with a signature frequency.

37. The method of claim 36, wherein the sensor further comprises a spectrum analyzer configured to produce an estimate of a received signal portion associated with at least two frequencies associated with a detection signature.

38. The method of claim 16, further comprising measuring capacitance/impedance at least one time.

39. The method of claim 38, wherein the method comprises measuring capacitance/impedance at least two times.

40. The method of claim 39, wherein a dose dependent increase in capacitance/impedance change indicates the presence of target biomolecules.

41. The method of claim 39, wherein a dose independent transient to capacitance/impedance indicates non-specific binding to the sensor surface.
